(19) United States
(12) Patent Application Publication
(10) Pub. No.: US 2009/0249458 A1
(43) Pub. Date: Oct. 1, 2009

(54) Systems and methods of network operation and information processing, including user engagement and profiling features

(76) Inventors: Jasminder Banga, San Francisco, CA (US); Nitin Shah, San Francisco, CA (US); Brijesh Patel, San Francisco, CA (US); Amul Patel, San Francisco, CA (US); Cleveland Ma, San Francisco, CA (US)

Correspondence Address: COURTNEY STANIFORD & GREGORY LLP, P.O. BOX 9686, SAN JOSE, CA, 95157, US

(21) Appl. No.: 11/523,374

(22) Filed: Sep. 18, 2006

Related U.S. Application Data
(60) Provisional application No. 60/717,857, filed on Sep. 16, 2005.

(51) Int. Cl. H04L 9/32; G06F 15/16; G06F 3/00

(52) U.S. Cl. 726/7; 709/229; 715/745; 707/200; 707/100; 707/3

(57) ABSTRACT

Embodiments of a system and method for network operation and information processing, including user engagement and profiling features are described. A method includes transmitting a request for authorization to use a public-access network from a computer, including, with the request, identifier information regarding the user. Data including additional information, such as a terms and conditions page, a splash page, relevant information based on user-specific information such as user location, and other like information is then transmitted over the network. The data to be transmitted is determined by processing software as a function of the identifier information regarding the user. A network connection is then opened up for the user of the computer.

### BACKGROUND

1. Technological Field

The present invention relates generally to systems and methods for network operation and information processing, and more specifically to systems and methods directed to user engagement and profiling features.

2. Description of Related Art

The emergence of the World Wide Web (“the Web”) over the past decade has spawned a vast online community of Internet users drawn by both the interactive multimedia content available on the Web and the ease of transacting business online. To a large extent, the proliferation of commercial activities on the Web (“E-commerce”) has been driven by online or virtual retailers and, more recently, by the online presence of traditional brick-and-mortar stores. In the context of such Web activity, the process of exchanging information itself is increasingly used by retailers, service providers and other related entities to achieve the most advantageous retail distribution and/or other commercial advantage.

Typically, Internet users obtain information from news-related sites, or portals, which offer links to sites that offer content that users are seeking, or through search engines that search the web to provide sites having useful information. To facilitate the providing of information and to benefit other entities operating on the Internet, information about the user is often collected for the purpose of improving the value of content delivered to the users. The accumulation of information concerning the recipients or prospective recipients of the content encompasses numerous methods and technologies, including profiling, tracing usage, using markers to track behavior, etc. Drawbacks with many known methods, however, are their inability into precisely target content to the individual user and their failure to inject appropriately customized or localized content (such as advertising, etc.) into the information sent to the user.

There are also drawback delivering content related to current user tracking technologies, such as cookie-based and other known user-marking functionality. For example, oftentimes a user must visit the site that set the marker before the customized content is available to be read. Moreover, present systems typically fail to recognize returning users, and so gather the same information and fail to aggregate user knowledge by updating repeat user profile information. With the rapid upsurge and continued growth in mobile computing, user-profile information stored with such limited tracking technologies can quickly become irrelevant or inaccurate. Thus, drawbacks are present with information processing and content delivery systems that continue to use such website-dependent user tracking and profiling functionality.

Another drawback of existing systems relates to the utilization of acquired user profile information. For example, present methods of delivering profile data typically fail to secure the transmission of the information, and there is no guarantee that the profile data is not accessible to other advertisers or entities. Therefore, drawbacks are also present with regard to systems and methods utilizing inadequate data sharing and exchange features with relevant third party entities, such as advertisers.

In general, traditional methods and systems for the delivery of content to customers use website-specific generalizations regarding user profile and behavior and are incapable of adaptive real-time delivery of targeted content to specific individuals. Moreover, even when some user profile data is available, current methods generally require complex correlations of disparate databases. Such correlations result in significant delay and degradation of performance so that end-users cannot get timely information customized to their immediate circumstances.

Thus, there is a need for efficient and adaptive learning methods and systems that process and accumulate website-independent user-profile related information, and that are capable of updating, adaptively processing and providing appropriate content in real time to increasingly mobile users.

### SUMMARY

In accordance with the present invention, systems and methods for network operation and information processing, including user engagement, user identification, and profiling features are presented.

According to some embodiments of the present invention, systems and methods for network operation and information processing are presented. In some embodiments, the method includes: transmitting a request for authorization to use the public-access network, including, with the request, identifier information regarding the user; transmitting first data including additional information (e.g., a terms and conditions page, a splash page, relevant information based on user-specific information such as user location, etc.), wherein the data to be transmitted is determined by the processing software as a function of the identifier information; and opening up a connection to the network for the user.

These and other embodiments are more fully described and their principles of operation explained in the following sections.

### BRIEF DESCRIPTION OF THE DRAWINGS

FIG. 1 is a block diagram illustrating an exemplary system for network operation and user identification, according to one or more embodiments of the present invention.

FIG. 2 is a block diagram illustrating further detail of an exemplary system for network operation and user identification, according to one or more embodiments of the present invention.

FIG. 3 is a block diagram illustrating authorization features and functionality for a first time user, according to one or more embodiments of the present invention.

FIG. 4 is a flow chart illustrating authorization functionality for a first time user, according to one or more embodiments of the present invention.

FIG. 5 is a block diagram illustrating authorization features and functionality for a returning user, according to one or more embodiments of the present invention.

FIG. 6 is a flow chart illustrating authorization functionality for a returning user, according to one or more embodiments of the present invention.

FIG. 7 is another block diagram illustrating authorization features and functionality for a returning user, according to one or more embodiments of the present invention.

FIG. 8 is another flow chart illustrating authorization functionality for a returning user, according to one or more embodiments of the present invention.

FIG. 9 is another block diagram illustrating authorization features and functionality for a returning user, according to one or more embodiments of the present invention.

FIG. 10 is another flow chart illustrating authorization functionality for a returning user, according to one or more embodiments of the present invention.

FIG. 11 is a block diagram illustrating features and functionality of profile data delivery related to ‘non-partner URL’ relationships, according to one or more embodiments of the present invention.

FIG. 12 is a block diagram illustrating features and functionality of profile data delivery related to ‘partner URL’ relationships, according to one or more embodiments of the present invention.

FIG. 13 is a block diagram illustrating features and functionality of data processing related to log recordation and storage aspects, according to one or more embodiments of the present invention.

FIG. 14 is a block diagram illustrating features and functionality of data processing related to terminology and revenue aspects, according to one or more embodiments of the present invention.

### DETAILED DESCRIPTION

The following detailed description of embodiments of the present invention refers to the accompanying drawings. Where appropriate, the same reference numbers in different drawings refer to the same or similar elements.

Systems and methods consistent with the present invention relate to user engagement, user identification, and user profiling features. As disclosed herein, embodiments of the invention may be implemented via various configurations of computer hardware and/or software, and may include transmitting data to users, gathering information related to users and performing related profile processing operations. For example, in accordance with an embodiment of the invention, first data including survey questions may be transmitted to the user. Answers to the survey questions may be used in connection with user information, device information, and/or user identifier information to create or maintain user profiles. As used herein, user identifier information relates to a wide variety of user-specific, device-specific, and/or access-point-specific data, as well as combinations thereof, capable of identifying a user with the desired specificity. Aspects of the above user identification and profile processing may then facilitate delivery of highly targeted information to users (such as ads) and implementation of personalized user experience and services (such as avoiding retransmission of previously-handled [viewed and/or acknowledged] information, providing other customized data, etc.).

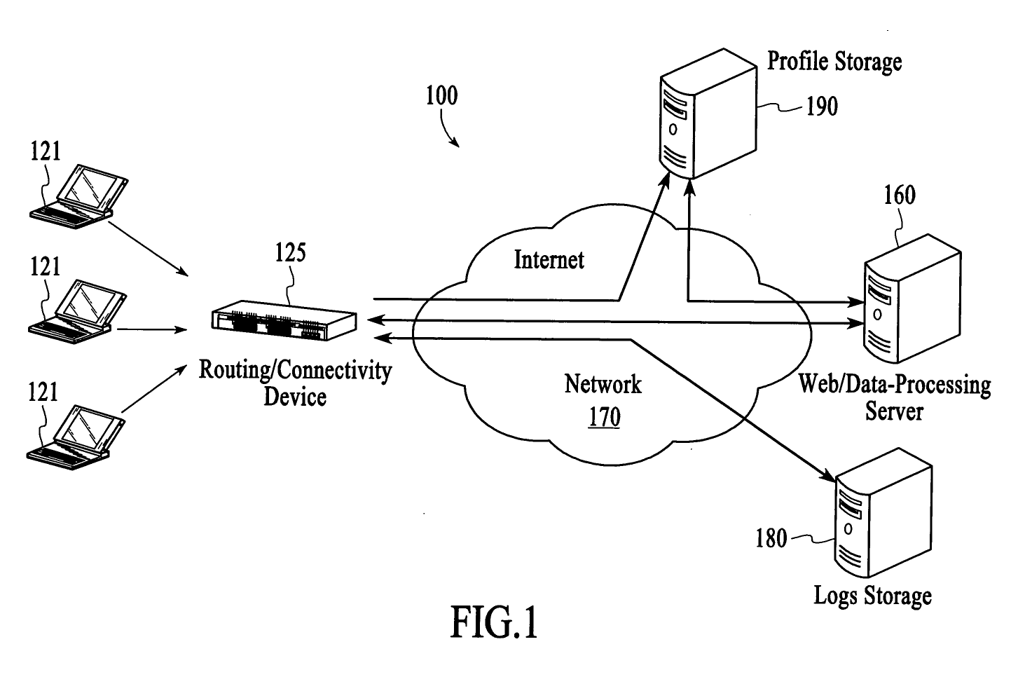

Referring to FIG. 1, a block diagram of an exemplary system is shown, consistent with one or more embodiments of the present invention. System 100 of FIG. 1 is comprised of the exemplary system hardware and software set forth below. Components of system 100 can alternately be implemented via any suitable unitary or distributed combination of hardware, software, and/or firmware. In the illustrated embodiment, system 100 includes users 121, a Routing/Connectivity Device 125 (“RCD”), and a Network/Data-Processing server 160 (“NDP server”), typically connected via a network 170 such as the World Wide Web. Specialized data processing between the RCD 125, the user 121, and the NDP server 160, over the network 170, is used to implement the various embodiments of user engagement, user identifier, and user profiling features disclosed herein. Additional elements are also associated with the network, such as a profile storage 190 component and a logs storage 180 component, although these components can also be integrated into or combined with other elements of the system, or eliminated altogether, according to one or more embodiments of the present invention.

Data processing associated with the present systems and methods can also be understood in terms of ‘session’ information processing and ‘permanent’ information processing. In general, session processing refers to information exchange between the user 121 and the RCD 125, and can also include data exchange related to the local information storage associated with the RCD 125. Permanent processing refers to information exchange between the NDP server 160 and the RCD 125 or user 121, as well as permanent information storage at the NDP server 160 or profile storage 190. Thus, information stored in NDP server 160 and/or profile storage 190 is updated over network 170 using information gathered by RCD 125 from users 121 connecting with or attempting to connect to the RCD 125. In some embodiments RCD 125 may request user and device profile information from the NDP Server 160, if it determines that a particular user or device has accessed the system on a prior occasion. In some embodiments, user or device profile information may be downloaded to a local network cache (not shown) for quicker access. In some embodiments, according to the present invention, multiple NDP servers may be used and physically and geographically distributed over network 170. Network 170 could be a LAN, WAN or the Internet. In some embodiments, the RCD 125 could be used with existing access point (“AP”) systems such as remote wireless access points/servers from generic providers, for example, Proxim, Linksys, Dlink, Compex, Buffalo Technologies, Netgear, Terabeam, Nomadix, and Plug Inn Go, etc. In some embodiments, the present information processing system may also be used or implemented with wired technology. Embodiments of the present system may also include signal amplifiers, external antennas, signal splitters, and other standard equipment as components.

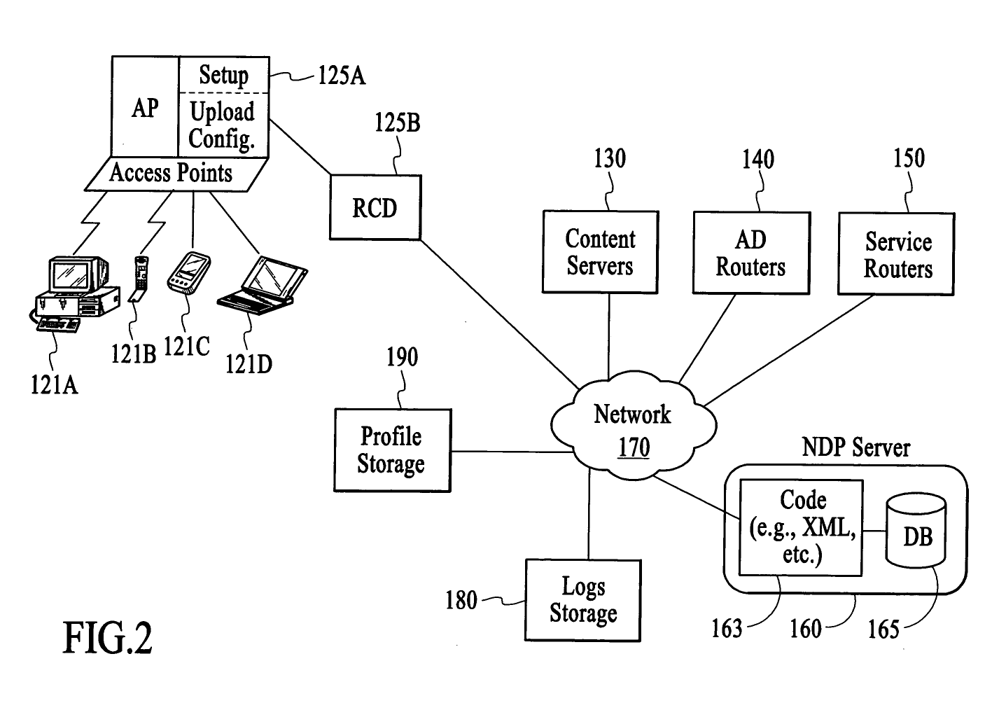

FIG. 2 illustrates another exemplary system 200 consistent with one or more embodiments of the present invention. As with the exemplary system of FIG. 1, system 200 of FIG. 1 is implemented by the combinations of hardware, software, and/or firmware set forth herein, or it can alternately be implemented via any suitable unitary or distributed combination of such elements. In the illustrated embodiment, system 200 is comprised of users 121, a first RCD component 125a (e.g., an access point, etc.), a second RCD component 125b (e.g., a gateway, a router, etc.), and an NDP server 160, connected via a network 170. Additional elements can also be included within the system 200 and/or associated with the network 170, such as content server 130, ad router 140, service router 150, logs storage 180 component, and profile storage 190 component. Again, all of these components can also be integrated into or combined with other elements of the system, or eliminated altogether, according to one or more embodiments of the present invention.

In one or more embodiments of the present invention consistent with FIG. 2, system 200 includes the following exemplary system software and hardware. In some embodiments, the servers and related systems shown in FIG. 2 may be standard off-the-shelf components. For example, the NDP Server 160 of the present invention may use a database 165, and it may be implemented with, e.g., Microsoft (“MS”) SQL Server, and/or other programs or code 163 to access and present information in the database. In some embodiments, systems may use languages such as SQL, XML, SOAP, ASP, and HTTP, etc. to enable interoperation (e.g., provide software hooks, etc.) and perform tasks, although any suitable programming language or tool could also be used.

For purposes of explanation, embodiments of the invention directed to network engagement through a wireless access point and associated routing device, consistent with FIG. 2, are discussed below. With regard to the session processing, each user or device 121a-121d can communicate with the access point 125A by a variety of wireless protocols. Exemplary details concerning some exemplary feature and functionality of such session processing are set forth in Appendix A. With regard to the permanent processing, connectivity between the NDP server 160 and the RCD components 125a (e.g., an access point) and 125b (e.g., a gateway) can be implemented by various communication protocols, according to one or more embodiments of the present invention. The gateway aspects of the RCD components need to communicate with the NDP server 160 software hooks to assist acquiring desired user data, and the location of the end user during the session. While the ‘gateway location’ generally provides sufficient resolution to capture user data associated with a specific user, non unique identification of users can occur if too many access points are connected per gateway. In this situation, other resolution techniques can be employed. Note that ‘gateway location’ is broadly defined and is not necessarily the actual physical location of the gateway. This ‘gateway location’ can also be location information relating to the gateway, or it can be the geographic center of aggregated coverage of all access points connected to the gateway.

For architectures having so many access points per gateway that resolution is compromised, the first RCD 125a (the access points) should be configured with VLAN (virtual LAN, or virtual local area network) so that an access point VLAN identifier or an access point identifier can be provided to the NDP server 160 when a user registers for a session. Additional information can also be used to provide individual user resolution. For example, user and/or device identifiers such as MAC addresses or other specialized information associated with a device such as a mobile computing device can be employed for this purpose. In connection with such mobile device access, whenever mobile devices roam across access points without needing to re-authenticate to the network service, features can be employed to provide updates to the NDP server 160 so that the user's location can be continuously updated during the session.

In some embodiments, when an end-user browses web sites using a computing device, the RCD 125 collects information regarding browsing habits and relays this information to NDP Server 160, where a database profile for the user and/or device may be updated. In some embodiments, the RCD 125 may also download information from NDP Server 160 and modify and send some of this information to content servers such as Content Server 130, to ad-related entities or components such as Ad Routers 140, and/or to service providing entities or components such as Service Router 150. In some embodiments, user and/or device profile information received by Content Server 130 from either the RCD 125 or the NDP server 160 may be used by Content Server 130 to determine which advertisements to retrieve from Ad Router 140. Content and advertising information are combined by Content Server 130 and sent to the RCD 125 for transmission to the users 121. In some embodiments, the RCD 125 may modify the content or advertising received over the network 170 based on device characteristics. For example, if client 121 is a handheld device, the format of the content may be modified to better suit the screen and other characteristics of that handheld device.

In order to effectively distribute or otherwise benefit from the user profile information, a site configuration database (e.g., part of, or similar to, database 165, etc.) can be maintained on one or both of the NDP server 160 and/or RCD 125. Among other data, this database stores the various identifier information associated with each user. The aggregate data contained in the site configuration database is particularly useful in situations when user resolution is compromised. This “compromise” occurs when the user information acquired by the system fails to have enough resultion to distinguish between users. In other words, data profiles from two or more users might be identical. To avoid such resolution issues, the site configuration database can maintain data such as: whether or not VLAN is use; VLAN IDs of all access points; gateway public IP addresses; gateway unique identifiers; geographic locations, such as the geographic location of all access points if VLAN is in use (or, e.g., of gateway coverage if VLAN is not in use); and formats of the interface functions, as well as any other parameter described herein. Aspects of this data can then be cross-referenced to identify each user with the desired level of certainty. Various real-time update processes are also employed to maintain the integrity of the site configuration database information. For example, if the gateway IP addresses are not statically assigned, an update process is implemented. Here, the NDP server 160 is configured to manage different implementations such as when the network operator provides updates, or when the required functionality is provided by means like notifications associated with dynamic DNS (Domain Name System) updates (i.e., updates associated with the Internet domain names to IP address translation system).

Various processes for engaging users of a public access network, as well as associated profiling functionality, are now disclosed, according to one or more embodiments of the present invention.

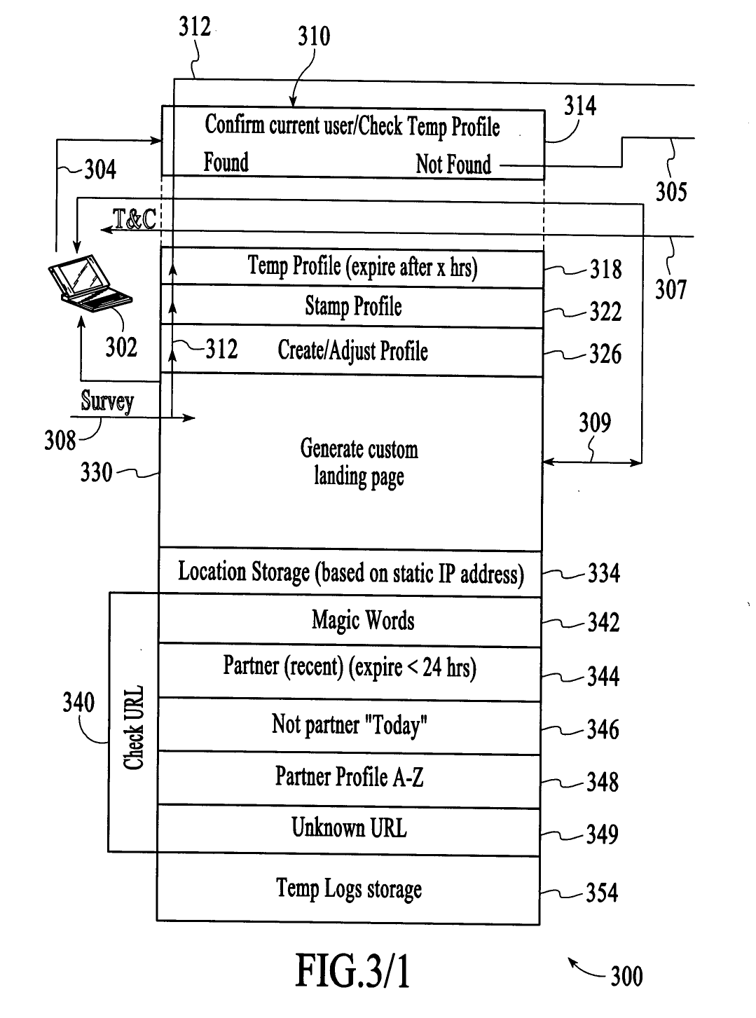

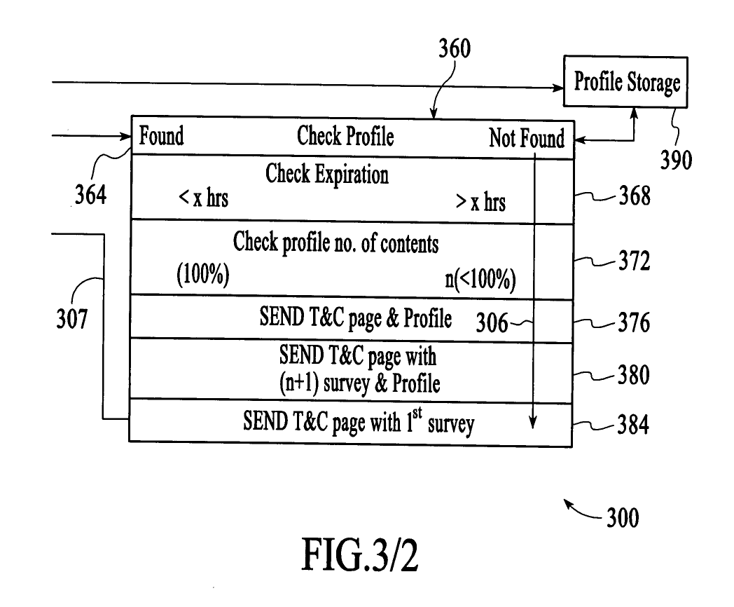

FIG. 3 is a block diagram illustrating authorization features and functionality for a first time user, according to one or more embodiments of the present invention. The first time user authorization regime 300 of FIG. 3 is comprised of a group of user-engagement modules 310, a group of data processing modules 360, and one or more profile storage elements 390. The modules (elements, features, functionality, routines, etc.) shown in FIG. 3 are implemented via a wide variety of discrete software and/or hardware configurations disclosed herein, or they may be implemented by any manner of distributed software and hardware configurations capable of serving the presently-described data processing methodologies. By way of example and not limitation, the embodiment illustrated in FIG. 3 is implemented with the user-engagement modules 310 located or associated with the RCD 125, with the data processing modules 360 located or associated with the NDP server 160.

According to the embodiment illustrated in FIG. 3, the user-engagement modules 310 include modules that implement the following features or functionality: confirm current user/check temporary profile 314, temporary profile expiration 318, stamp profile 322, create/adjust profile 326, deliver information 330 (e.g., custom landing page, etc.), location storage 334, check URL components 340, and temporary logs storage 354. The check URL components 340 include a magic words process 342, a partner process 344, supplemental partner processes 346, a partner profile process 348, and an unknown URL process 349. Further, the data processing modules 360 include modules that perform the following features or functionality: check permanent profile 364, check expiration 368, check profile contents 372, generate first data 376, generate first data including partial survey 380, and generate first data including initial survey 384.

While numerous features of the relevant information processing environment are illustrated in the embodiment of FIG. 3, not all of these features are involved with each and every user engagement process. For example, a first time user authorization process is illustrated in connection with the arrows shown in FIG. 3. In this first time user authorization process, a user 302 first initiates a request to connect with the network 304, such as by transmitting a URL that the user desires to visit. In response to this request, the system first checks to confirm prior existence of this user in the temporary profile storage 314. If the user is a recent user, the system would find a corresponding profile in the temporary profile database and implement further processing associated with the user-engagement features/elements 310. However, in the first time user embodiment illustrated by the arrows in FIG. 3, no temporary profile exists for a new user, so the system passes the user information 305 to the data processing modules 360.

In connection with the data processing features/elements 360, the system verifies, in the check profile module 364, the user information against the permanent profile information. The permanent profile information can be stored, for example, in profile storage 390, which can be any suitable internal or external server/storage location. Here again, however, no permanent profile exists for a new user, so the system initiates a first data transmission process 306. In this new user module, first data including initial survey module 384, the system generates first data including an initial survey for the user. This first data is then transmitted to the user 307.

According to this exemplary embodiment, the user 302 next responds to the survey questions 308, such as by transmitting their answers to the user-engagement modules 310 (e.g., to the RCD or access point). Using this new or updated information, in connection with processing at a deliver information module 330, the user-engagement modules 310 generate a custom landing page 309 and delivers it to the user 302. From the landing page, full or conditioned use of the network can also be enabled. Additionally, while the deliver information processes are occurring, for example, the user-engagement modules 310 can also transmit the new user information 312, such as profile information, to profile storage 390 for subsequent processing.

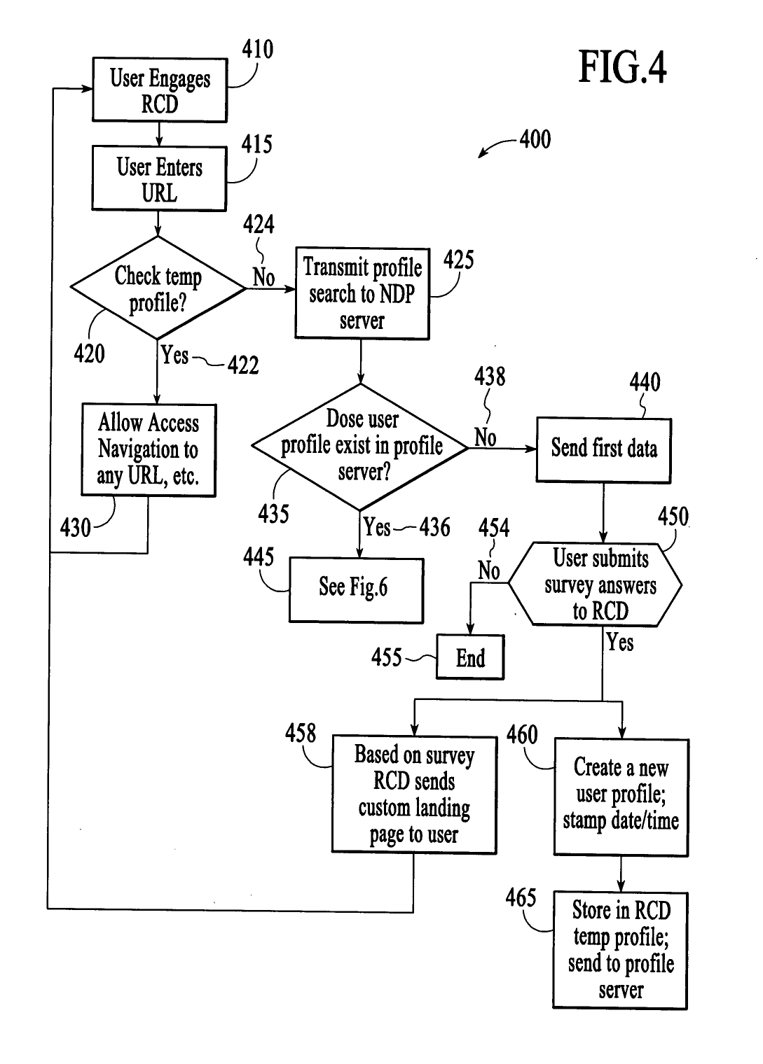

FIG. 4 is a flowchart depicting a first user-engaging process 400 illustrating one exemplary engagement process for a first time user, according to one or more embodiments of the present invention. To begin, a user engages the RCD 410 (such as an access point), e.g., by selecting or initiating an access-enabling SSID and attempting to access the Internet. The access-enabling SSID is acquired in a variety of ways. For example, users can employ wireless management software to scan and add the SSID enabling association with the desired access point software. Users can also pre-configure their wireless access profile with the appropriate SSID made available by any entity related to the transaction, such as an RCD- or NDP server-related entity. In this case, the SSID can be downloaded from any suitable website, or otherwise made available by the entity. Additionally, users can gain enhanced/secured Internet access by installing, or otherwise obtaining, pre-packaged software created for this purpose.

After successful connection to the RCD, the user enters initial engagement data 415, which can include a desired URL. This initial engagement information is transmitted to the NDP server. Various user identification data is also acquired by the NDP server along with the desired URL data. As used herein, terms associated with this acquisition of user identification information, such as “acquire,” “transmit,” “provide,” etc., refer broadly to any dissemination of the information discussed herein, such as transmission (push) or detection (pull). Thus, these terms encompass receipt of information by any means ranging from active transmission of the information by the computing devices to any variety of information collection using associated software and/or hardware.

Upon receipt of the initial engagement information and user identification data, a processing component such as the RCD performs a check temporary profile step 420 to compare the user information against the user profiles stored in the temporary profile server. If a profile corresponding to the user information does exist 422 in the temporary profile module, then the RCD either enables access to the Internet 430 or initiates additional processing. This additional processing can include further verification or authentication processes that must be satisfied prior to granting the user access to the Internet.

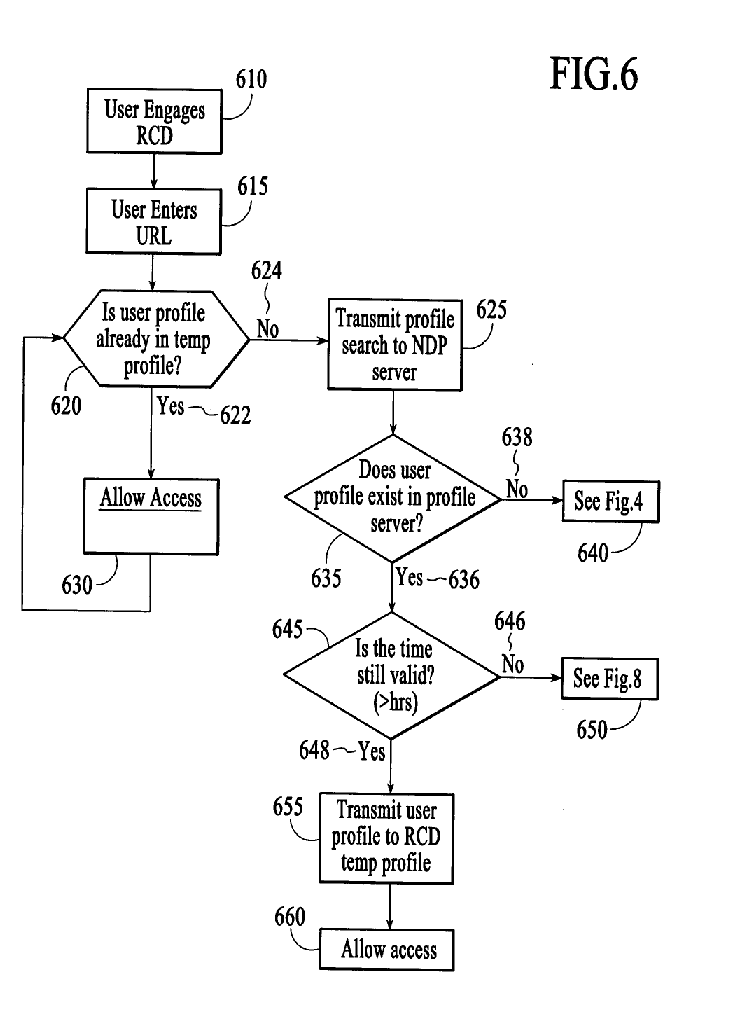

If the corresponding profile does not exist 424 in the temporary profile module, the RCD transmits the user information to the NDP server 425 for comparison with the profile database. The NDP server then determines whether or not a profile exists in the profile database for this particular user or user data 435. If the NDP server finds a corresponding user profile 436, it verifies user data 445, as described in more detail in connection with FIG. 6. If the NDP server finds no corresponding profile 438, it sends first data to the user 440. This first data is, for example, any of the first data discussed throughout this disclosure. For purposes of illustration, this discussion contemplates first data that includes a terms and conditions page with a first survey directed to the user.

In reply to the receipt of the first data, the user responds such as by acknowledging the terms and conditions and/or answering the survey 450. If the user's response is a decision not to accept/acknowledge the terms and conditions and/or survey 454, the RCD would then typically terminate the connection 455. If the terms and conditions or survey are accepted/acknowledged, the RCD transmits customized information to the user 458. For example, the RCD might send a landing page customized as a function of user-specific information, such as the user's location, the user's answer to the survey question, etc. At the same time, the RCD creates a new profile for the new user 460. The new profile can include any of a variety of information or data associated with the user. For example, the new profile information can include usage or tracking information (e.g., timestamps, visitation and/or prior usage information, etc.), and/or other information that enables more effective targeting and delivery of customized content to the user. After the transmission of customized information 458 and profile creation 460 steps, the user is granted access to the Internet. This access can be either unlimited, or it can be conditioned upon either a desired term (e.g., expiration of time period), other usage information, or other data monitored in association with the user or tracked/stored in the profile databases.

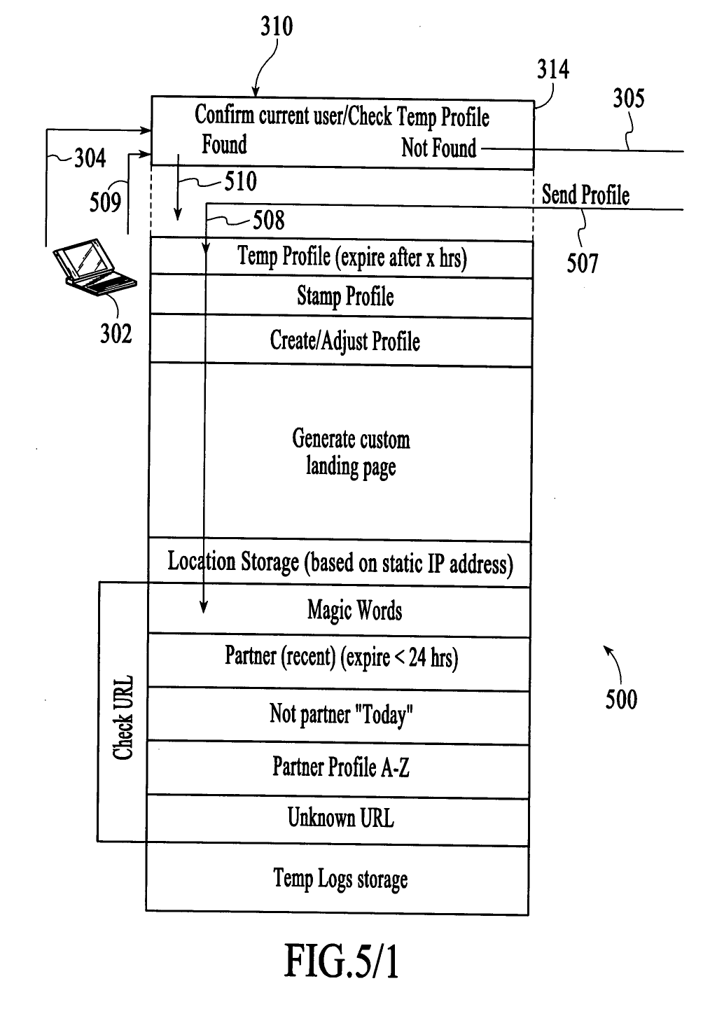

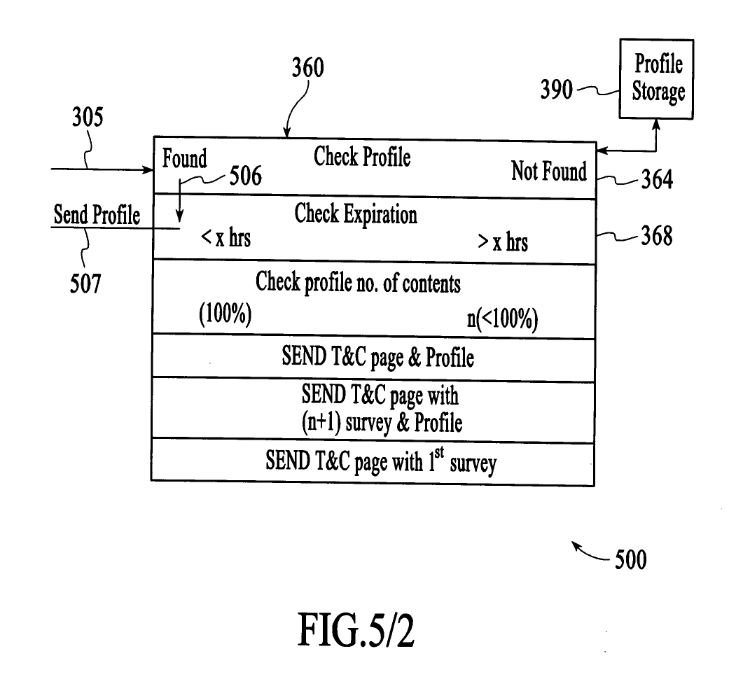

FIG. 5 is a block diagram illustrating authorization features and functionality for a returning user, according to one or more embodiments of the present invention. The returning user authorization regime 500 of FIG. 5 uses the same group of user-engagement modules 310, group of data processing modules 360, and profile storage elements 390 set forth above in connection with FIG. 3. Similarly, the modules (elements, features, functionality, routines, etc.) shown in FIG. 5 are implemented via a wide variety of discrete software and/or hardware configurations disclosed herein, or they may implemented via any manner of distributed software and/or hardware configurations capable of serving the presently-described data processing methodologies.

According to the embodiment illustrated in FIG. 5, the user-engagement modules 310 and the data processing modules 360 can implement all of the modules, features, and functionality discussed above. The present returning user embodiment employs only a limited number of these modules, specifically, confirm current user/check temporary profile 314 module, check permanent profile 364 module, and check expiration 368 module. Although the remaining modules are not discussed again here for the sake of convenience, this and other embodiments of the present invention can also include steps involving all of these other features.

A returning user authorization process is illustrated in connection with the arrows shown in FIG. 5, according to the present embodiment. In the returning user authorization regime 500 of FIG. 5, a user 302 first initiates a request to connect with the network 304, such as by transmitting a URL that the user desires to visit. In response to this request, the system first checks to confirms existence of a profile for this user or user data in the temporary profile storage 314. If the user is a returning user having visited in the recent past, as is discussed in more detail below, the system finds a corresponding profile in the temporary profile database and implements further processing associated with the user-engagement modules 310. However, in the returning user embodiment illustrated by the arrows in FIG. 5, no temporary profile exists for the exemplary returning user, so the system passes the user data/information 305 to the data processing modules 360.

In connection with the data processing modules 360, the present regime 500 then verifies, in the check profile module 364, whether a profile exists in the permanent profile information for that user or user data. As with the embodiment of FIG. 3, the permanent profile information can be stored in one or more profile storage 390 locations. Here, however, a permanent profile would already exist for the returning user, so the system initiates a data transmission process 506 for a user having an existing profile. As an initial step in this profiled user process, the system performs a first check to determine if the user, user login, or other user-related data obtained satisfied threshold requirements, such as a threshold condition. In the present embodiment, for example, the threshold requirement is a time expiration check in check expiration 368 module. Here, then, the system might check to see if the user is returning within a specified time period allotted during their previous use, such as 2 hours. If the returning access is within the allotted time, the data processing modules 360 transmit 507, back to the user engagement modules 310, both authorization for the user to continue his use of the network as well as the relevant user profile information for further processing/use by the user engagement modules 310. Next, the user engagement modules 310 store the profile in the temporary profile storage and let the user access the network. During this session, any subsequent request for a URL 509 simply finds the user information stored in temporary profile storage 314 and allow the user immediate access 510.

FIG. 6 is a flowchart depicting a second user-engaging process 600 illustrating one engagement process encountered by a returning user, according to one or more embodiments of the present invention. To begin, a user engages the RCD (such as an access point), e.g., by selecting or initiating an access-enabling SSID and attempting to access the Internet. Again, the access-enabling SSID is acquired by suitable means, such as those described above or in any other known manner.

After successful connection to the RCD, the user submits initial engagement data 615, which can include a desired URL. This initial engagement information is transmitted to the NDP server. As with the above-described embodiments, various user identification data is also acquired by the NDP server along with the desired URL data.

Upon receipt of the initial engagement information and user identification data, a processing component such as the RCD performs a check temporary profile step 620 to compare the user information against the user profiles stored in the temporary profile server. If a profile corresponding to the user information does exist 622 in the temporary profile module, the RCD either enables access to the Internet 630 or initiates additional processing. This additional processing can include further verification or authentication processes, as set forth in connections with FIG. 4.

If a corresponding profile does not exist 624 in the temporary profile server, the RCD transmits the user information to the NDP server 625 for comparison with the profile database. The NDP server then determines whether or not a profile exists in the profile database for this particular user or user information 635. If the NDP server does not find a corresponding profile 638, it initiates further processing 640 as set forth above in connection with FIG. 4. If the NDP server does find a corresponding user profile 636, it can initiate the following user verification processes.

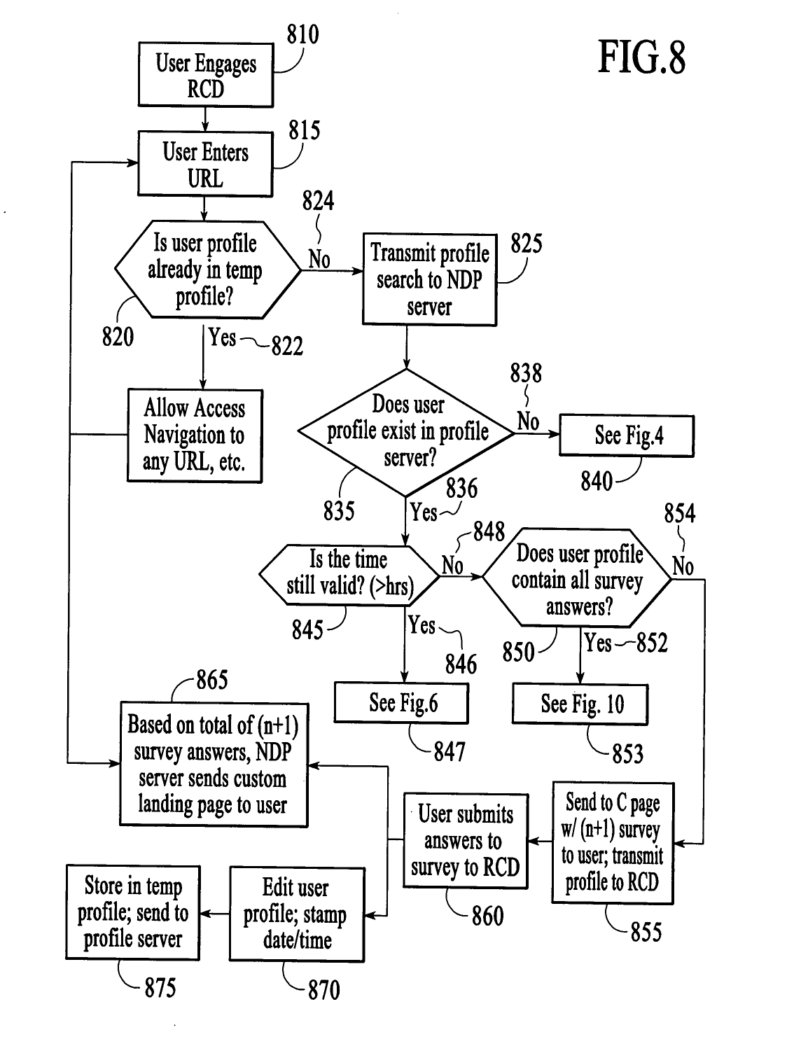

An exemplary user verification process is now disclosed, according to one or more embodiments of the present embodiment. As an initial step in such exemplary existing-profile user process, the system performs a first check to determine if the user or user data obtained by the system satisfy one or more threshold requirements, such as a threshold condition. In the present embodiment, for example, the threshold requirement is a check time expiration step 645. Again, according to this embodiment, the system checks to see if the user is returning within the allotted two-hour usage period. If the NDP server determines that the time period has expired 646, it initiates further processing 650 as set forth above in connection with FIG. 8. If the returning access is within the allotted time 648, the NDP server transmits information back to the user-engagement modules 655, including, e.g., authorization for the user to continue its use of the network as well as the relevant user profile information for further processing/use by the user engagement modules. Finally, the RCD either enables access to the Internet 660 or initiates additional processing. This additional processing can include further verification or authentication processes, as set forth in connections with FIG. 4.

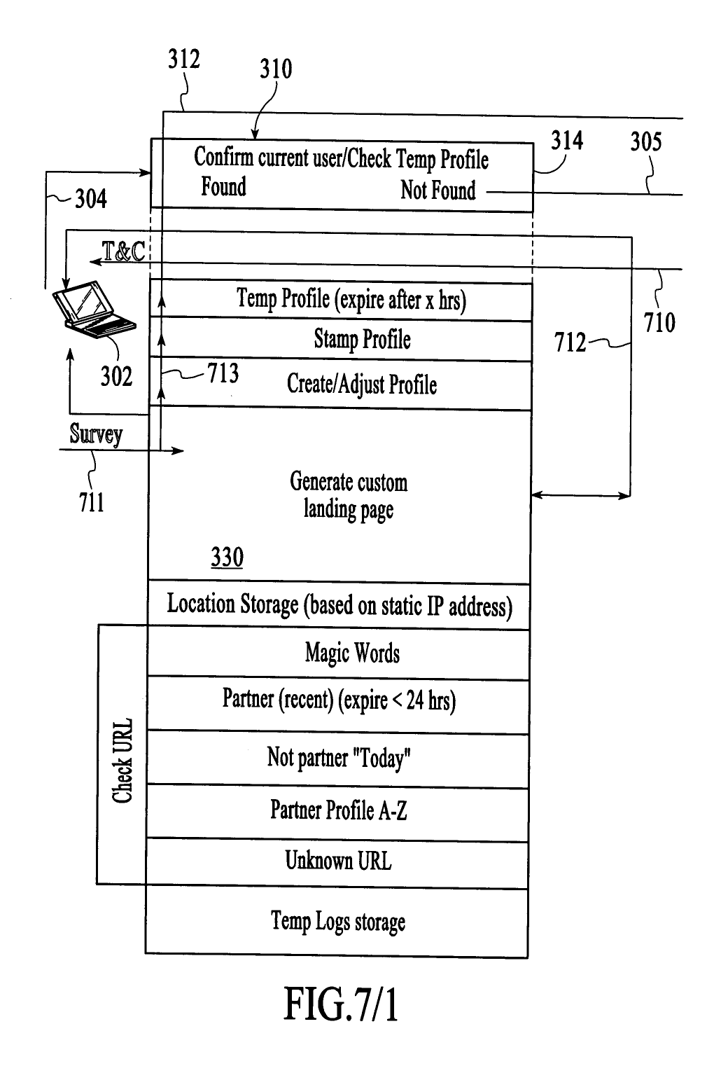

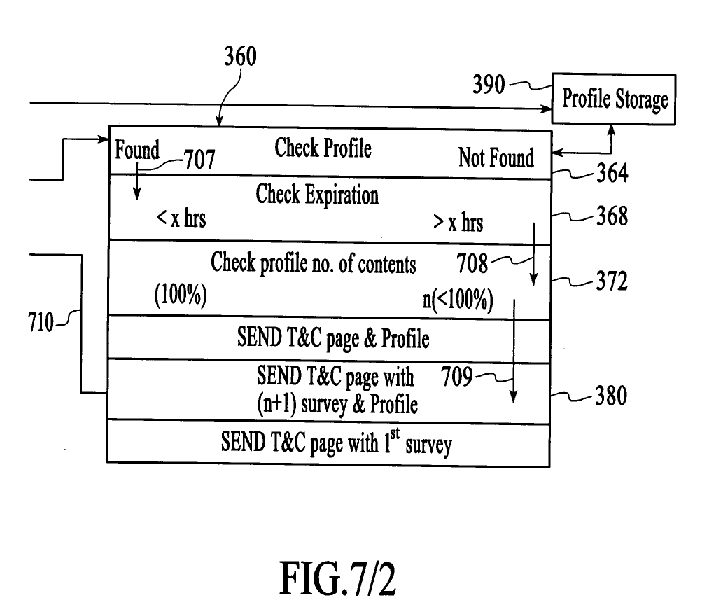

FIG. 7 is a block diagram illustrating authorization features and functionality for a returning user, according to one or more embodiments of the present invention. The returning user authorization regime 700 of FIG. 7 uses the same groups of user-engagement modules 310, data processing modules 360, and profile storage elements 390 set forth above in connection with FIGS. 3 and 5. Similarly, the modules (elements, features, functionality, routines, etc.) shown in FIG. 7 are implemented via a wide variety of discrete software and/or hardware configurations disclosed herein, or may be implemented via any manner of distributed software and/or hardware configurations capable of serving the presently-described data processing methodologies.

According to the embodiment illustrated in FIG. 7, the user-engagement modules 310 and the data processing modules 360 can implement all of the modules, features, and functionality discussed throughout. The present returning user embodiment, however, employs only a limited number of these modules. Specifically, return user regime 700 employs confirm current user/check temporary profile 314 module, check permanent profile 364 module, check expiration 368 module, check profile contents 372 module, and generate first data including partial survey 380 module. Although the remaining modules are not discussed again here for the sake of convenience, this and other embodiments of the present invention can also involve all of these other features.

In the returning user authorization regime 700 of FIG. 7, a user 302 first initiates a request 304 to connect with the network, such as by transmitting a URL that the user desires to visit. In response to this request, the system first checks to confirms existence of a profile for this user or user data in the temporary profile storage 314. If the user was a returning user having visited in the recent past, as is discussed in more detail below, the system would find a corresponding profile in the temporary profile database and implement further processing associated with the user-engagement modules 310. However, in the returning user embodiment illustrated by the arrows in FIG. 7, no temporary profile exists for this exemplary returning user, so the system passes the user data/information 305 to the data processing modules 360.

In connection with the data processing modules 360, the present regime 700 would then verify, in the check profile module 364, whether a profile exists in the permanent profile information for that user or user data. As with the embodiments of FIGS. 3 and 5, the permanent profile information can be stored in one or more profile storage 390 locations. Here, a permanent profile already exists for the returning user, so the system initiates additional existing-profile processing 707 for the present user. As an initial step in this existing-profile process, the system would perform a first check to determine if the user- or use-related data satisfied one or more threshold requirements, such as a threshold condition. In the present embodiment, for example, the threshold requirement is a time expiration check in check expiration 368 module. Here, the system might check to see if the user is returning within a specified time period allotted during their previous use, such as 2 hours. If the returning access is not within the allotted time, the data processing modules 360 would then initiate a review 708 of the latest profile information for that user. This review, performed by the check profile contents 372 module, can verify, e.g., whether all of the latest profile information has been collected for the present user. For example, the check profile contents 372 module can determine if the answers to any surveys or survey questions are yet outstanding for that user. If profile information remains outstanding in this embodiment, the system then utilizes the generate first data including partial survey 380 module to generate and transmit 710 a terms and conditions page with the desired survey to the user engagement modules 310 for delivery to the users.

According to this embodiment of regime 700, the user 302 next responds to the survey questions 711, such as by transmitting their answers to the user-engagement modules 310 (e.g., to the RCD, access point, etc.). Using this new or updated information, in connection with processing at a deliver information module 330, the user-engagement modules 310 can then generate a custom landing page 712 and deliver it to the user. From the landing page, full or conditioned use of the network can then also be enabled. Additionally, while the deliver information processes are occurring, for example, the user-engagement modules 310 can also transmit the new user information 713, such as updated profile information, to profile storage 390 for subsequent processing.

FIG. 8 is a flowchart depicting a third user-engagement process 800 for a returning user, according to one or more embodiments of the present invention. To begin, a user first engages 810 the RCD or user engagement modules (such as via an access point), e.g., by selecting or initiating an access-enabling SSID and attempting to access the Internet. Here again, the access-enabling SSID is acquired by suitable means, such as those described above or by any other known manner.

After successful connection to the RCD, the user submits initial engagement data 815, which can include a desired URL. This initial engagement information is transmitted to the NDP server. As with the above-described embodiments, various user identification data is also acquired by the NDP server along with the desired URL data.

Upon receipt of the initial engagement information and user identification data, a processing component such as the RCD performs a check temporary profile step 820 to compare the user information against the user profiles stored in the temporary profile server. If a profile corresponding to the user information does exist 822 in the temporary profile module, then the RCD either enables access to the Internet 830 or initiates additional processing. This additional processing can include further verification or authentication processes, as set forth in connections with FIG. 4.

If a corresponding profile does not exist 824 in the temporary profile server, the RCD transmits the user information to the NDP server 825 for comparison with the profile database. The NDP server then determines whether or not a profile exists in the profile database for this particular user or user information 835. If the NDP server does not find a corresponding profile 838, it initiates further processing 840 as set forth above in connection with FIG. 4. If the NDP server does find a corresponding user profile 836, it can initiate the following user verification processes.

An exemplary user verification process is now disclosed, according to one or more embodiments of the present embodiment. As an initial step in such exemplary profiled user process, the system can perform a first check to determine if the user (or user data) obtained by the system satisfies one or more threshold requirements, such as a threshold condition. In the present embodiment, for example, the threshold requirement is a check time expiration step 845. Again, according to this embodiment, the system checks to see if the user is returning within the allotted two-hour usage period. If the NDP server determines that the time period has expired 846, it initiates further processing 847 as set forth above in connection with FIG. 6. If the returning access is within the allotted time 848, the NDP server would then initiate further profile processing steps.

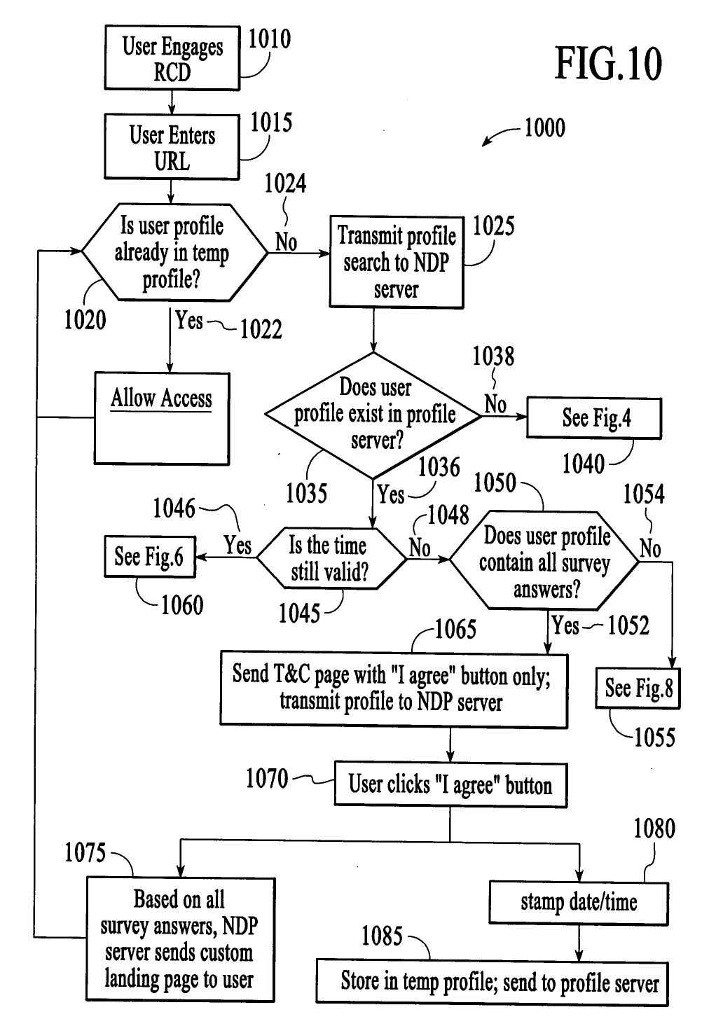

For example, the NDP server can determine whether the relevant user profile includes all current survey answers 850. If the user profile does contain all survey answers 852, the NDP server can initiate additional steps 853 including transmission of first data that does not include queries regarding survey questions. Examples of such first data, according to one or more embodiments of the present invention, are set forth in connection with FIG. 10, steps 1065-1085.

If the user profile does not contain all survey answers 854, the NDP server can then execute a survey update step 855. The survey update step 855 can include transmission of first data to the user including the unanswered survey questions. The survey update step 855 can also include transmission of the present profile information to the RCD for use at the session level. Next, the user submits his or her answer(s) to the survey questions to the RCD 860.

The NDP server then processes the information associated with the survey answers 865. During this phase, the NDP server first receives the new survey answers from the user. Then, the NDP server performs targeted profile processing using any of the user profile information in its possession, including the existing survey answers and the new survey answers. The NDP server next transmits customized first data to the user based on this targeted profile processing. For example, the NDP server can send a custom landing page to the user customized as a function of user-specific information, such as the user's answer to the survey question, the user's location, etc.

In association with this step of survey information processing 865, the NDP server also updates and/or edits the user profile 870. This editing and/or updating would generally comprise the integration of any new information concerning the user into the user profile. With regard to the present example, this editing could include an update to the day and time stamps that are then used for subsequent processing according to these exemplary embodiments. Finally, the profile databases are updated with the edited user profile 875. This update step can include, for example, storage of the new profile information into a temporary profile database, as well as transmission of the new profile information to the profile server(s).

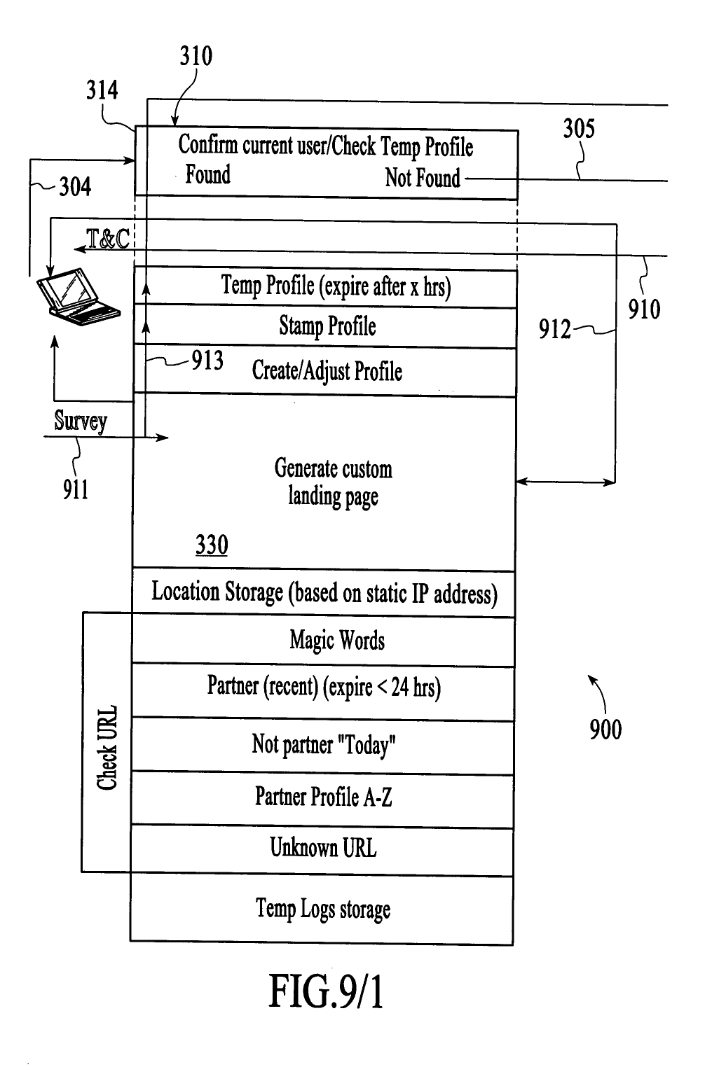

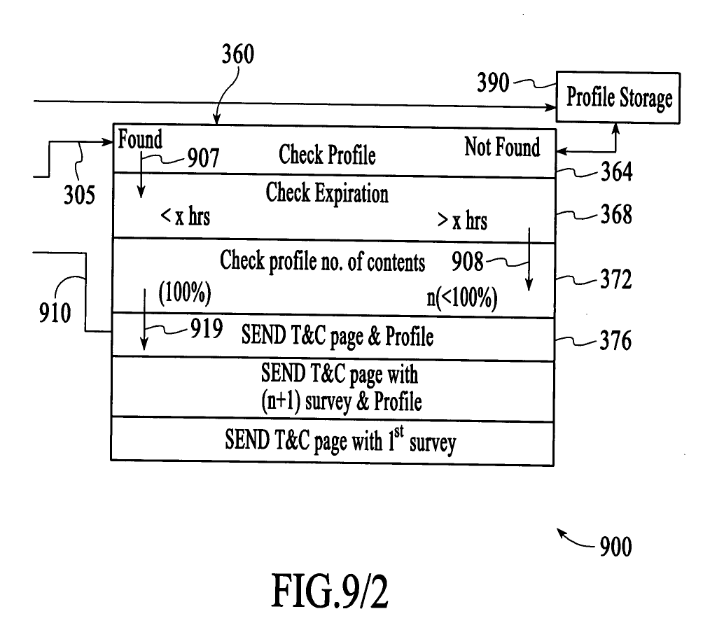

FIG. 9 is a block diagram illustrating authorization features and functionality for a returning user, according to one or more embodiments of the present invention. The returning user authorization regime 900 of FIG. 9 uses the same groups of user-engagement modules 310, data processing modules 360, and profile storage elements 390 set forth above in connection with FIGS. 3, 5 and 7. Similarly, then, the modules (elements, features, functionality, routines, etc.) shown in FIG. 9 are implemented via a wide variety of discrete software and/or hardware configurations disclosed herein, or they may be implemented via any manner of distributed software and/or hardware configurations capable of serving the presently-described data processing methodologies.

According to the embodiment illustrated in FIG. 9, the user-engagement modules 310 and the data processing modules 360 can implement all of the modules, features, and functionality discussed throughout. The present returning user embodiment, however, employs only a limited number of these modules. Specifically, returning user regime 900 employs confirm current user/check temporary profile 314 module, check permanent profile 364 module, check expiration 368 module, check profile contents 372 module, and generate first data 376 module. Although the remaining modules are not discussed again here for the sake of convenience, this and other embodiments of the present invention can also involve all of these other features.

In the returning user authorization regime 900 of FIG. 9, a user 302 first initiates a request 304 to connect with the network, such as by transmitting a URL that the user desires to visit. In response to this request, the system first checks to confirms existence of a profile for this user or user data in the temporary profile storage 314. If the user was a returning user having visited in the recent past, as is discussed in detail elsewhere, the system would find a corresponding profile in the temporary profile database and implement further processing associated with the user-engagement modules 310. However, in the returning user embodiment illustrated by the arrows in FIG. 9, no temporary profile exists for this exemplary returning user, so the system passes the user data/information 305 to the data processing modules 360.

In connection with the data processing modules 360, the present regime 900 verifies, in the check profile module 364, whether a profile exists in the permanent profile information for that user or user data. As with the embodiments of FIGS. 3, 5 and 7, the permanent profile information can be stored in one or more profile storage 390 locations. Here, a permanent profile already exists for the returning user, so the system initiates additional existing-profile processing 907 for the present user. As an initial step in this existing-profile process, the system would perform a first check to determine if the user- or usage-related data satisfied one or more threshold requirements, such as a threshold condition. In the present embodiment, for example, the threshold requirement is a time expiration check in check expiration 368 module. Here, the system might check to see if the user is returning within a specified time period allotted during their previous use, such as 2 hours. If the returning access is not within the allotted time, the data processing modules 360 would then initiate a review 908 of the latest profile information for that user. This review, performed by the check profile contents 372 module, verifies whether all of the latest profile information has been collected for the present user. For example, the check profile contents 372 module can determine if the answers to any surveys or survey questions are yet outstanding for that user. If profile information is completely current for the user, the system then initiates a send data step 910, including transmission of a terms and conditions page to the user engagement modules 310 for delivery to the user. The send data step 910 can also include transmission of the full user profile information back to the user engagement modules 310.

According to this embodiment of regime 900, the user 302 next responds to 911 the terms and conditions page, such as by transmitting his or her acceptance to the user-engagement modules 310. With the acceptance in place, the user-engagement modules 310 can then generate a custom landing page 912 and deliver it to the user. From the landing page, full or conditioned use of the network can then also be enabled. Additionally, while the deliver information processes are occurring, for example, the user-engagement modules 310 can also transmit the new user information 913, such as updated profile information, to profile storage 390 for subsequent processing.

FIG. 10 is a flowchart depicting a fourth user-engagement process 1000 for a returning user, according to one or more embodiments of the present invention. To begin, a user engages 1010 the RCD or user engagement modules by selecting or initiating an access-enabling SSID and attempting to access the Internet. Here again, the access-enabling SSID is acquired by suitable means, such as those described above or by any other known manner.

After successful connection to the RCD, the user submits initial engagement data 1015, including a desired URL. This initial engagement information is transmitted to the NDP server. As with the above-described embodiments, various user identification data is also acquired by the NDP server along with the desired URL data.

Upon receipt of the initial engagement information and user identification data, a processing component such as the RCD performs a check temporary profile step 1020 to compare the user information against the user profiles stored in the temporary profile server. If a profile corresponding to the user information does exist 1022 in the temporary profile module, then the RCD either enables access to the Internet 1030 or initiates additional processing. This additional processing can include further verification or authentication processes, as set forth in connections with FIG. 4.

If a corresponding profile does not exist 1024 in the temporary profile server, the RCD transmits the user information to the NDP server 1025 for comparison with the profile database. The NDP server then determines whether or not a profile exists in the profile database for this particular user or user information 1035. If the NDP server does not find a corresponding profile 1038, it initiates further processing 1040 as set forth above in connection with FIG. 4. If the NDP server does find a corresponding user profile 1036, it can initiate the following user verification processes.

A user verification process is now disclosed, according to one or more embodiments of the present embodiment. As an initial step in such exemplary existing-profile user process, the system can perform a first check to determine if the user or user data obtained by the system satisfy one or more threshold requirements, such as a threshold condition. In the present embodiment, for example, the threshold requirement is a check time expiration step 1045. According to one embodiment, the system checks to see if the user is returning within the allotted two-hour usage period. If the NDP server determines that the time period is still valid 1046, it initiates further processing 1060 as set forth above in connection with FIG. 6. If the returning access occurs after the time period has expired 1048, the NDP server would then initiate further profile processing steps.

For example, the NDP server can determine whether the relevant user profile includes all current survey answers 1050. If the user profile does not contain all survey answers 1054, the NDP server initiates additional processing steps 1055 as set forth in connection with FIG. 8. If the user profile does contain all survey answers, the NDP server initiate the following processing steps, including transmission of first data that does not include additional queries or survey questions.

If the user profile does contain all survey answers 1052, the NDP server then transmits first data 1065. According to the present embodiment, this first data transmission step 1065 includes transmission of a basic terms and conditions page with an “I agree” button. This step an also include transmission of the present profile information to the RCD for use at the session level. Next, the user submits his or her acceptance of the terms and conditions to the RCD 1070.

The RCD then processes the information associated with the profile information received from the NDP server. During this step 1075, the RCD transmits a custom landing page to the user based on their profile information. For example, the NDP server can send a custom landing page to the user customized as a function of user-specific information, such as the user's answer to previous survey questions, the user's location, etc.

In association with such exemplary custom landing page functionality, the RCD can also update the user information, user profile, and/or other usage data with the current usage information. For example, any such user-related data can be stamped with date and/or time information so that the system maintains record of the user's most recent access. Finally, in at least one profile update step 1085, the updated user profile is stored in the temporary profile storage and also sent to the profile server for permanent storage.

Embodiments of the present invention also include functionality for ensuring that profile data is delivered only to advertisers or other third parties that have an established business relationship with the system provider. To illustrate this functionality, profile delivery to advertisers in connection with wireless access point embodiments is discussed next. As background, each RCD 125 in such wireless embodiments may seek to identify the user and/or indemnify the network operator from the user's actions attributable to the network connection. To identify the user, the RCD 125 typically supports or requires web-page redirection for some type of user authentication. Further, the network operator of the RCD typically requires a terms and conditions page before establishing Internet access to obtain, e.g., disclaimer for any issues or actions arising from usage of the network connection.

With regard to identifying the user, the above functions allow the NDP server 160 to collect information from the RCD 125 when the web page redirects. These identification processes can acquire desired user information via several techniques associated with the transmission of first data, such as terms and conditions pages. For example, during the redirect, the terms and conditions page can either be supplied either by the provider of the NDP server system (with redirection to their own server) or by a third party. If a third party (e.g., the network operator) provides the terms and conditions page, HTML and javascript are used to (i) collect the answers to profile questions, (ii) build the Terms and Conditions page correctly, and (iii) exchange information. In some embodiments, the RCD 125 can then collect the following information: the MAC address of client device; the local IP address of client device; the public IP address of gateway to which the client device connects; the VLAN ID of the access point (if applicable); and the gateway identifier. The NDP server 160 is also capable of building session identifiers as a function of such information, which are then provided to the advertisers. The session identifiers also include the client devices' local IP addresses, which can be requested from the RCD by a javascript “include” function. According to these embodiments, the advertisers then use the session identifiers to ask the NDP server for user profiles so they can provide customized information to be served in association with the various Web pages delivered.

The NDP server system can also be partnered with the various URLs, for example, to facilitate greater data exchange. While selection of partner URLs provides certain content delivery advantages (i.e., the ability to deliver customized or modified content), interaction with non partner URLs effects faster response time for delivery of unmodified information to the user.

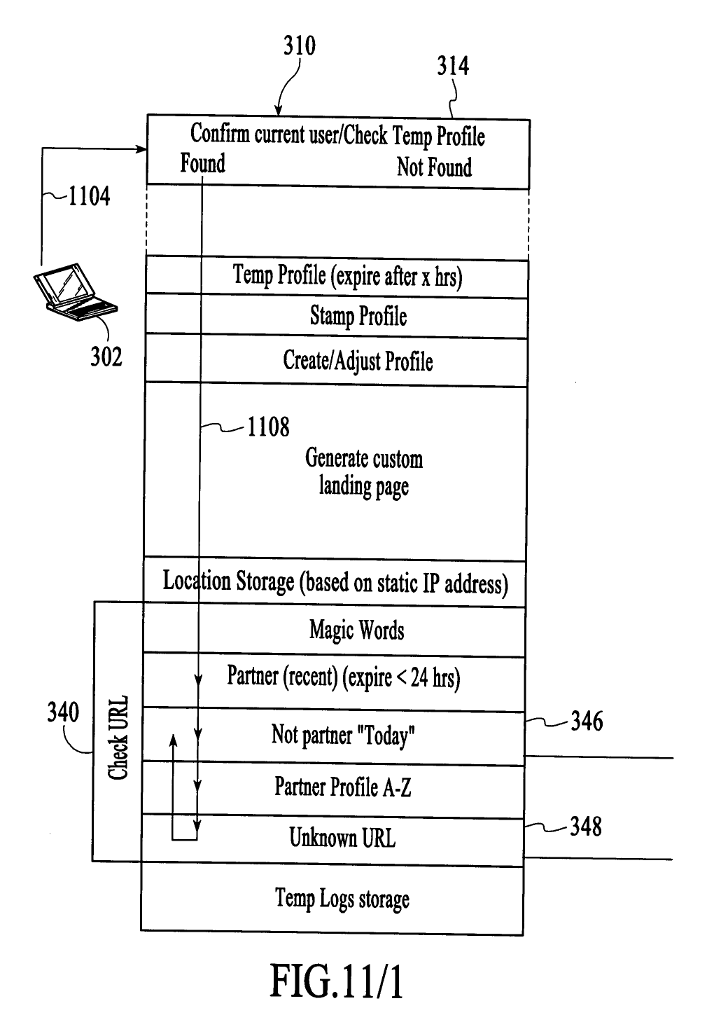

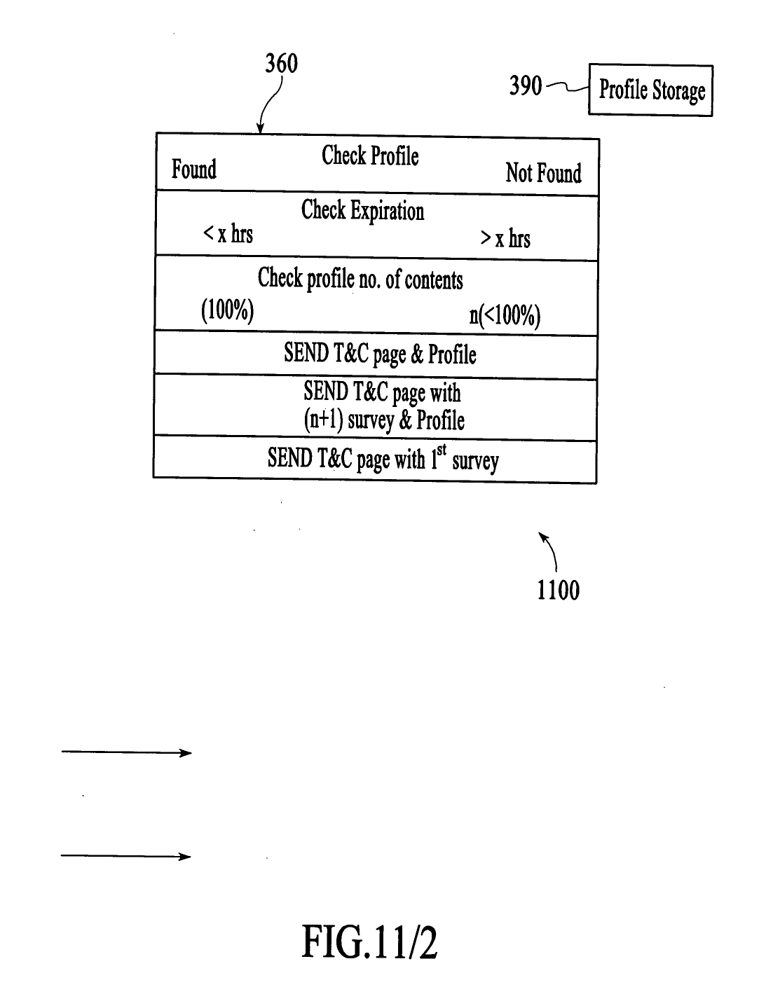

FIG. 11 is a block diagram illustrating features and functionality of profile data delivery related to ‘non-partner URL’ relationships, according to one or more embodiments of the present invention. The non-partner URL regime 1100 of FIG. 11 is explained in the context of the same user-engagement modules 310, data processing modules 360, and profile storage elements 390 set forth above. As a first step, the user 302 submits a URL 1104 as their desired web destination. The RCD then transmits the URL data 1108 to a URL processing module and performs various check URL 340 processes against a database of partner URLs. The check URL 340 processes can include, inter alia, a not partner today process 346 and a compare to partner profile 348 process. The partner profile process 348 include steps such as checking the URL against the list of partner URLs and also ensuring that the relevant partnership agreement, if one exists, has not expired. Prior to or after this step, the RCD can also verify whether a non-partner relationship was already and recently confirmed. Furthermore, if the URL is a non-partner URL, many of the other partner-related processing can be skipped via use of a non-partner URL list (as explained below). In the presently described embodiment, no partnership arrangement exists with the URL, so the RCD simply sends the URL without any modification of content. At the same time, the URL is designated to a ‘not partner’ list by a ‘not partner today’ process 346 so that the RCD can immediately verify subsequent URL requests by checking them against this non-partner URL list. This affords faster response to the user, as it enables immediate transmission of unmodified content.

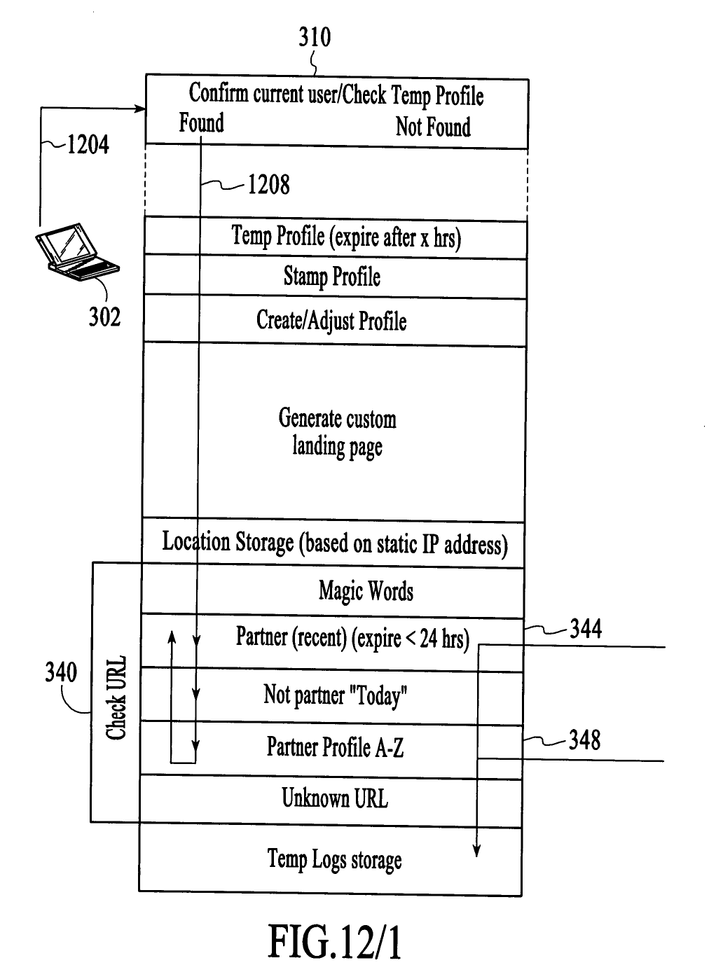

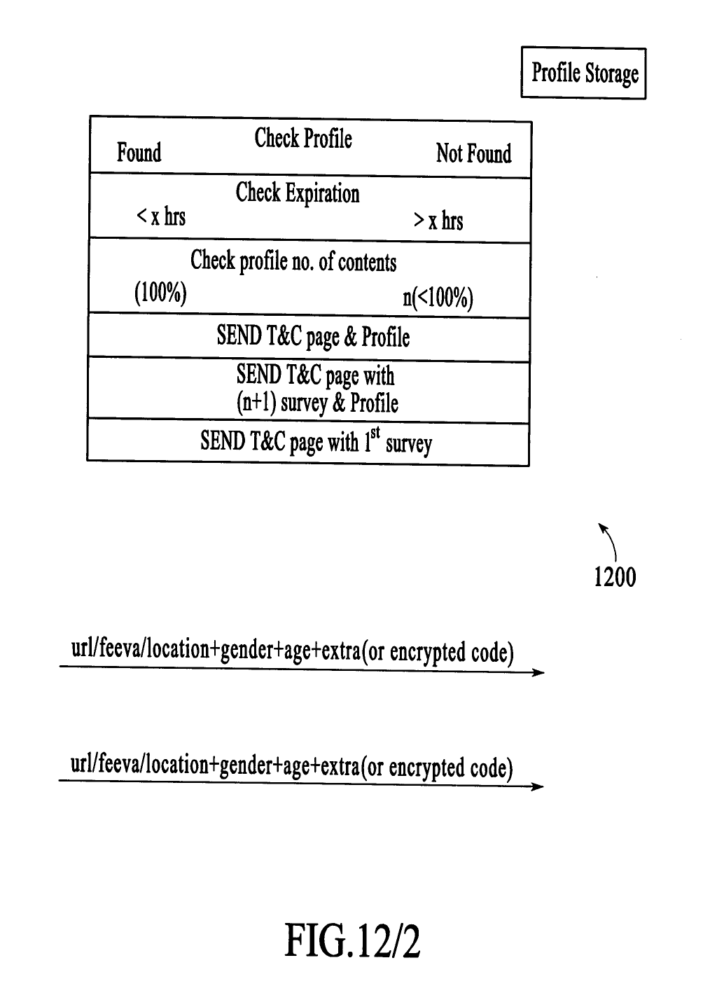

FIG. 12 is a block diagram illustrating features and functionality of profile data delivery related to ‘partner URL’ relationships, according to one or more embodiments of the present invention. The partner URL regime 1200 of FIG. 12 is explained in the context of the user-engagement modules 310 set forth above in connection with FIG. 11. In this regime, the user 302 first submits a URL 1204 as their desired web destination. The RCD then transmits the URL data 1208 to a URL processing module and performs various check URL 340 processes against a database of partner URLs. The check URL 340 processes can include, inter alia, a recent partner process 344 and a compare to partner profile 348 process. The partner profile 348 process includes steps such as checking the URL against the list of partner URLs and also ensuring that the relevant partnership agreement, if one exists, has not expired. Prior to or after this step, the RCD can also verify whether a non-partner relationship was already and recently confirmed. In the presently described embodiment, a partnership arrangement exists with the URL, so the RCD sends the URL with modified content that can be, e.g., keyed to the user profile. The RCD can also maintain a record of the partner URL in the temporary logs storage with the date and time stamp to facilitate faster verification of partnership for later-requested URLs. Finally, the URL is designated as a ‘partner URL’ and placed in a “recent” partner list by a recent partner process 344 to avoid unnecessary future processing to verify the partnership arrangement.

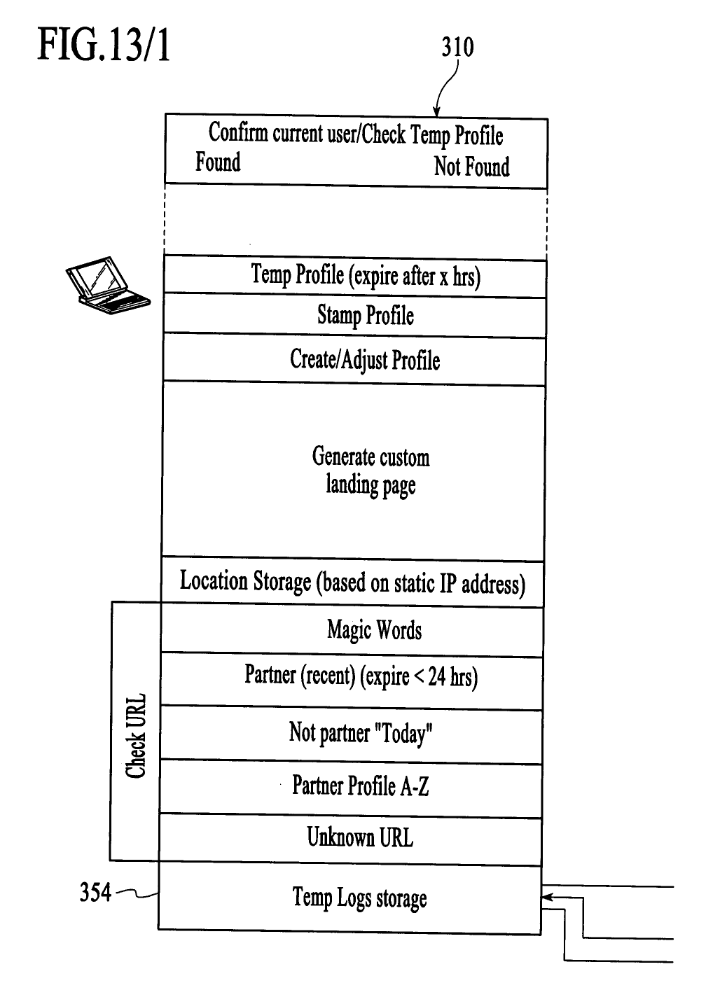

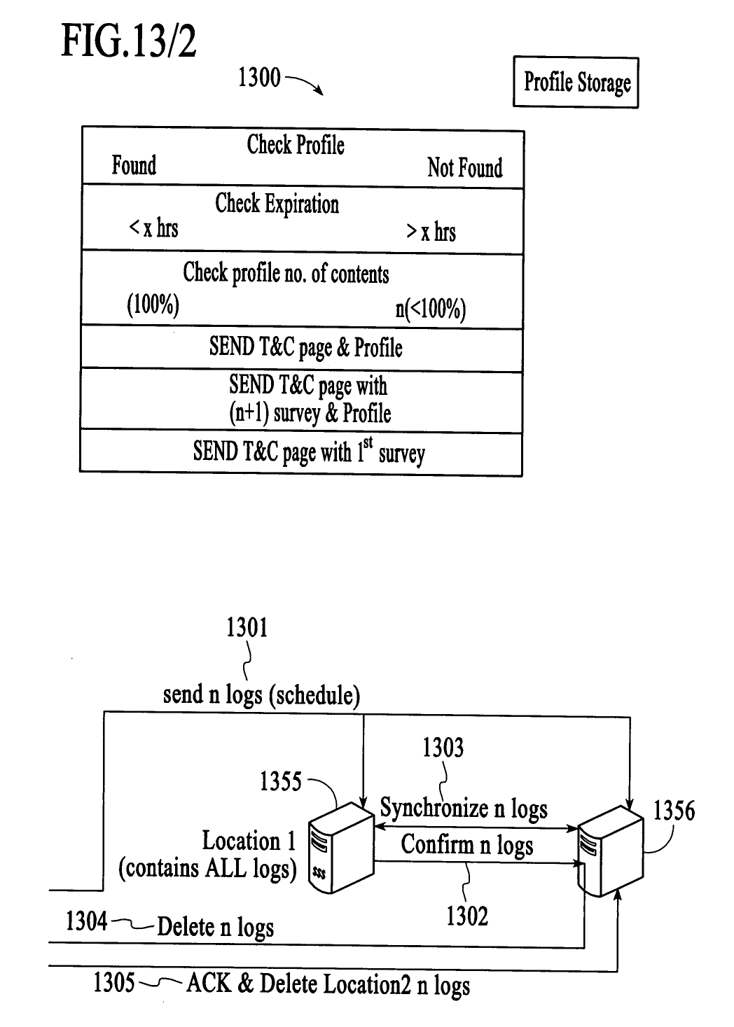

FIG. 13 is a block diagram illustrating features and functionality of data processing related to log recordation and storage, according to one or more embodiments of the present invention. The log storage regime 1300 of FIG. 13 is explained in the context of the user-engagement modules 310 set forth above in connection with FIGS. 3, 5, 7, 9,11, and 12. Log storage regime 1300 pertains to update processing including automatic updates to the temporary logs storage 354 module. As used herein, log information is comprised of usage information associated with each user, such as URLs visited, that is not necessarily stored as part of the user profile. This logs information can be stored at the local RCD for a time, but is best utilized by transmission to a central logs server for subsequent distribution to and use by any other RCD in the system. In one embodiment, as shown in FIG. 13, temp logs storage 354 transmits n logs 1301 to a first location 1355 (e.g., an intermediate logs server) and to a second location 1356, e.g., during a period of less network traffic. The first location 1355 then confirms 1302 with the second location 1356 that it received n logs from the temporary logs storage. The second location 1356 then synchronizes 1303 with the first location 1355 so it can then initiate a delete request 1304 to delete the n logs as safely received. Temporary logs storage 354 then authorizes deletion of the n logs 1305. Finally, the first location 1355 sends all confirmed logs to a central logs server (not shown) for permanent storage.

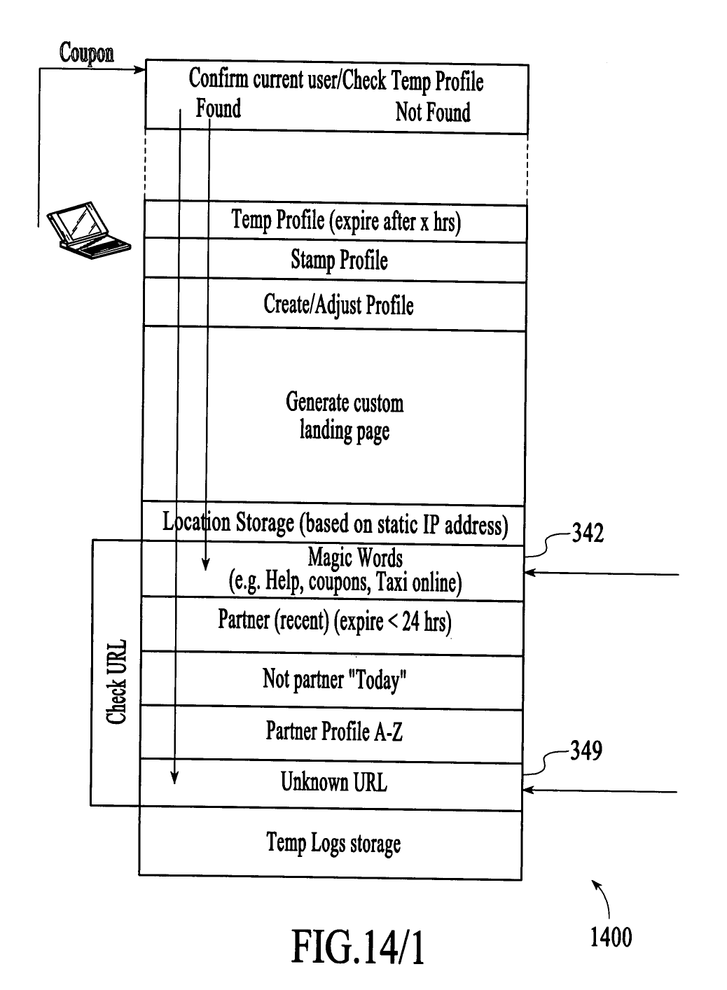

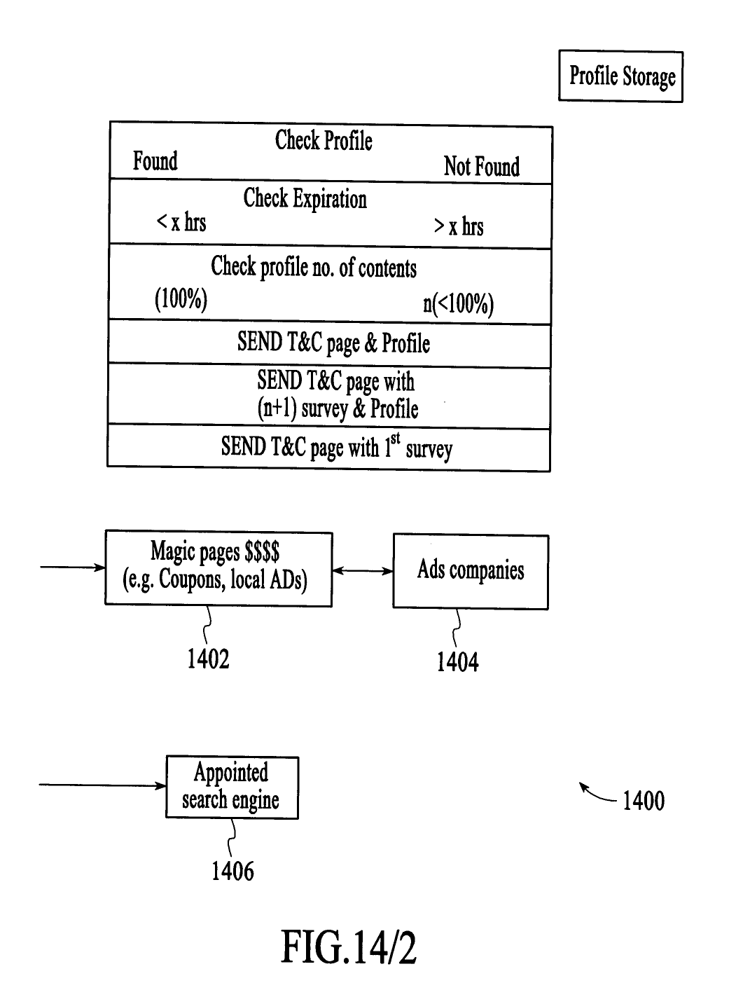

FIG. 14 is a block diagram illustrating features and functionality of data processing related to terminology and revenue aspects, according to one or more embodiments of the present invention. The terminology regime 1400 of FIG. 14 is explained in the context of the user-engagement modules 310 set forth above in connection with FIGS. 3, 5, 7, 9,11,12, and 13. Exemplary functionality used in connection with a magic words module 342 is first described, according to one or more embodiments of the present invention. Here, when a user enters one or more words recognized by the system (e.g., words typed into the URL address bar, as recognized by the RCD, the NDP server, etc.), the user receives an exclusive local Webpage 1402 that is typically associated with an advertising, publishing or service company 1404. For example, the expression “[servername]coupon” could provide all coupons available to the server or system within a 1 mile radius of the user. The present system, due to its location at the front end of the Internet, can also intercept all unknown URLs. Thus, the present system, via unknown URL module 349, can direct a user who has entered an incorrect or unknown URL to, for example, any search engine or other Webpage specified or appointed by the system 1406. Embodiments of the present invention utilize this redirection functionality to provide significant advantage over known search engine functionality.

Other embodiments of the invention will be apparent to those skilled in the art from consideration of the specification and practice of the invention disclosed herein. It is intended that the specification and examples be considered as exemplary only, with a true scope and spirit of the invention being indicated by the disclosure above in combination with the following paragraphs describing the scope of one or more embodiments of the following invention.

1. A method of engaging users of a public-access network, the method comprising:
associating a processing component within the public-access network, wherein processing software is associated with the processing component;
transmitting a request, associated with a user of an access device, to authorize use of the public-access network, including transmission, in association with the request, of identifier information regarding the user;
transmitting first data wherein the first data to be transmitted is determined by the processing software as a function of the identifier information; and
opening up a connection for the user;
wherein the processing software determines whether the user is a first time user or a returning user as a function of the identifier information.

2. The method of claim 1, wherein, for first time users, the first data transmitted is a terms and conditions page and an information-gathering process/request/survey, and a custom landing page is generated as a function of the identification information and/or other information gathered regarding the user.

3. The method of claim 1, wherein the processing software checks one or more profile databases to determine if the user is a first time user/has an existing profile.

4. The method of claim 3, wherein the profile databases include a temporary/local profile database and a main profile storage database.

5. The method of claim 1, wherein the first data transmitted includes at least one further information-gathering process/request if the time elapsed since the user's last login is greater than an expiration period.

6. The method of claim 1 wherein the user is provided unrestricted access to the Internet.

7. The method of claim 1, wherein the user is provided conditional access to the Internet.

8. The method of claim 1, wherein data based on the location of the ads delivered is saved and used to charge advertising entities based on the effectiveness of the delivery/ad.

9. A method of engaging/becoming associated with users of a public-access network, comprising:
(a) associating a processing component within the public-access network, wherein processing software is executed in connection with the processing component;
(b) transmitting a request, associated with a user of the access device, for authorization to use the public-access network, including transmission of identification information for the user with the request;
(c) determining whether the user is a first time user or a returning user as a function of the identification information;
(d) transmitting first data wherein the first data to be transmitted is determined by the processing software as a function of the user's identification information;
(e) providing access to the network for that specific user.

10. The method of claim 9, wherein, for first time users, the first data transmitted is a terms and conditions page and an information-gathering process/request/survey, and a custom landing page is generated as a function of the identification information and/or other information gathered regarding the user.

11. The method of claim 9, wherein the processing software checks one or more profile databases to determine if the user is a first time user/has an existing profile.

12. The method of claim 11, wherein the profile databases include a temporary/local profile database and a main profile storage database.

13. The method of claim 9, wherein the first data transmitted includes at least one further information-gathering process/request if the time elapsed since the user's last login is greater than an expiration period.

14. The method of claim 9 wherein the user is provided unrestricted access to the Internet.

15. The method of claim 9, wherein the user is provided conditional access to the Internet.

16. The method of any of claim 8 wherein data based on the location of the ads delivered is saved and used to charge advertising entities based on the effectiveness of the delivery/ad.

17. A method of engaging/becoming associated with users of a public-access network, comprising:
(a) associating a processing component within the public-access network, wherein processing software is executed in connection with the processing component;
(b) transmitting a request, associated with a user of the access device, for authorization to use the public-access network, including transmission of identification information for the user with the request;
(c) determining whether the user is a first time user or a returning user as a function of the identification information;
(d) transmitting first data wherein the first data to be transmitted is determined by the processing software as a function of the user's identification information;
(e) providing access to the network for the user.

18. The method of claim 17, wherein, for returning users, the first data transmitted is a terms and conditions page and an information-gathering process/request/survey, and a custom landing page is generated as a function of the identification information and other information gathered regarding the user including whether or not all previous survey questions have been answered.

19. The method of claim 18 wherein, when a returning user has answered all previous survey questions, a connection is opened/Internet is accessed without requesting/receiving any additional user information.

20. The method of claim 17, wherein the profile databases include a temporary/local profile database and a main profile storage database.

21.-32. (canceled)
